(19) United States
(12) Patent Application Publication
(10) Pub. No.: US 2009/0013192 A1
(43) Pub. Date: Jan. 8, 2009

(54) INTEGRITY CHECK METHOD APPLIED TO ELECTRONIC DEVICE, AND RELATED CIRCUIT

(76) Inventors: Ping-Sheng Chen, Chiayi County (TW); Ming-Yang Chao, Hsin-Chu Hsien (TW); Chi-Chun Hsu, Taipei County (TW); Yao-Dun Chang, Hsinchu City (TW); Tse-Hong Wu, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 11/772,829

(22) Filed: Jul. 3, 2007

(51) Int. Cl. G06F 12/14

(52) U.S. Cl. 713/189

(57) ABSTRACT

An integrity check method applied to an electronic device includes: fetching at least one portion of external data into a specific memory, where the external data is stored within the electronic device; during fetching the portion of the external data into the specific memory, checking whether the size of the fetched data in the specific memory reaches a predetermined value, where the predetermined value is less than the total size of the external data; and when the size of the fetched data in the specific memory reaches the predetermined value, enabling an integrity check of the fetched data.

### BACKGROUND

The present invention relates to security of electronic devices, and more particularly, to integrity check methods applied to electronic devices, and related circuits.

For security considerations, preventing control-related data from being altered or checking whether the control-related data is altered is essential for the latest optical storage devices such as blu-ray disc (BD) drives and high definition digital versatile disc (HD-DVD) drives. An integrity check of the control-related data such as a firmware code is one approach to this issue.

For an optical storage device, performing an integrity check of control-related data in the same way as a BIOS of a personal computer (PC) is not suitable since a quick response to an inquiry of a host device handling the optical storage device (e.g. a controller/control circuit on a motherboard within a PC) is strongly recommended. If the host device receives no response from the optical storage device within a predetermined time interval, for example, a couple of hundreds of milliseconds, the optical storage device may be considered to be unavailable, leading to a malfunction.

According to the related art, as the control-related data is typically stored in a memory whose access speed is considered insufficiently fast (such as a non-volatile memory), the control-related data can first be entirely fetched into a dynamic random access memory (DRAM) or a static random access memory (SRAM) within the optical storage device, so the integrity check of the control-related data is performed therein. If the optical storage device is provided with more or improved functions, however, the control-related data would be too great to be checked in time. As a result, the control-related data may be utilized before the integrity check is performed, which means the security of the optical storage device is very weak.

### SUMMARY

It is therefore an objective of the claimed invention to provide integrity check methods applied to electronic devices, and related circuits, to solve the problems mentioned above.

It is another objective of the claimed invention to provide integrity check methods applied to electronic devices, and related circuits, to increase the efficiency during operations required for performing an integrity check.

It is another objective of the claimed invention to provide integrity check methods applied to electronic devices, and related circuits, to enhance the security of the electronic devices.

An exemplary embodiment of an integrity check method applied to an electronic device comprises: fetching at least one portion of external data into a specific memory, where the external data is stored within the electronic device; during fetching the portion of the external data into the specific memory, checking whether the size of the fetched data in the specific memory reaches a predetermined value, where the predetermined value is less than the total size of the external data; and when the size of the fetched data in the specific memory reaches the predetermined value, enabling an integrity check of the fetched data.

An exemplary embodiment of a circuit for performing an integrity check in an electronic device comprises: a specific memory for temporarily storing at least one portion of external data, where the external data is stored within the electronic device; and a microprocessor, coupled to the specific memory, for fetching the portion of external data into the specific memory, where during fetching the portion of the external data into the specific memory, the microprocessor checks whether the size of the fetched data in the specific memory reaches a predetermined value, and the predetermined value is less than the total size of the external data. When the size of the fetched data in the specific memory reaches the predetermined value, the microprocessor enables the integrity check of the fetched data. These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of an integrity check method applied to an electronic device according to one embodiment of the present invention.

FIG. 2 is a diagram of a circuit that can be utilized for performing the integrity check method shown in FIG. 1.

FIG. 3 is a flowchart of an integrity check method applied to an electronic device according to one embodiment of the present invention.

FIG. 4 illustrates the data to be fetched from the non-volatile memory as mentioned in the integrity check method shown in FIG. 3.

FIG. 5 is a flowchart of an integrity check method applied to an electronic device according to one embodiment of the present invention.

FIG. 6 is a diagram of a circuit that can be utilized for performing the integrity check method shown in FIG. 5.

FIG. 7 illustrates a specific portion of the data stored in the non-volatile memory mentioned in the deriving step shown in FIG. 1, FIG. 3, or FIG. 5 according to one embodiment of the present invention, where the specific portion includes parameters for controlling the corresponding fetching step.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

The present invention provides integrity check methods applied to a wide range of electronic devices on the market such as optical storage devices, cellular phones, and personal digital assistants (PDAs). In particular, according to some embodiments of the present invention, the electronic devices can be embedded systems.

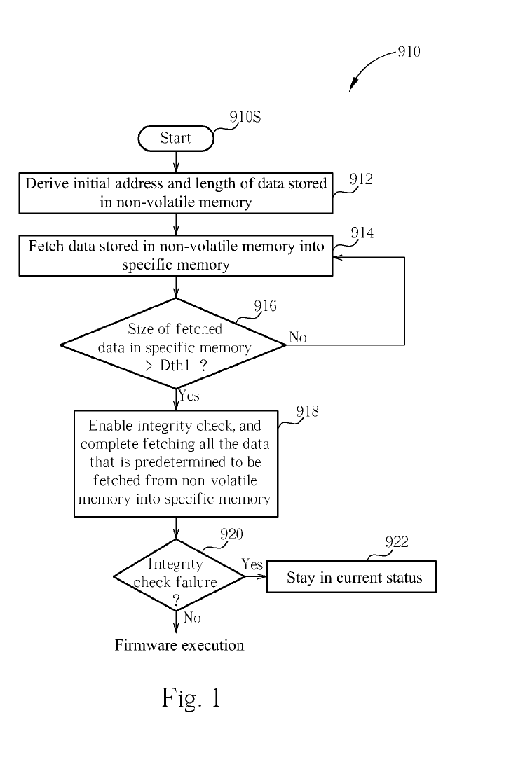

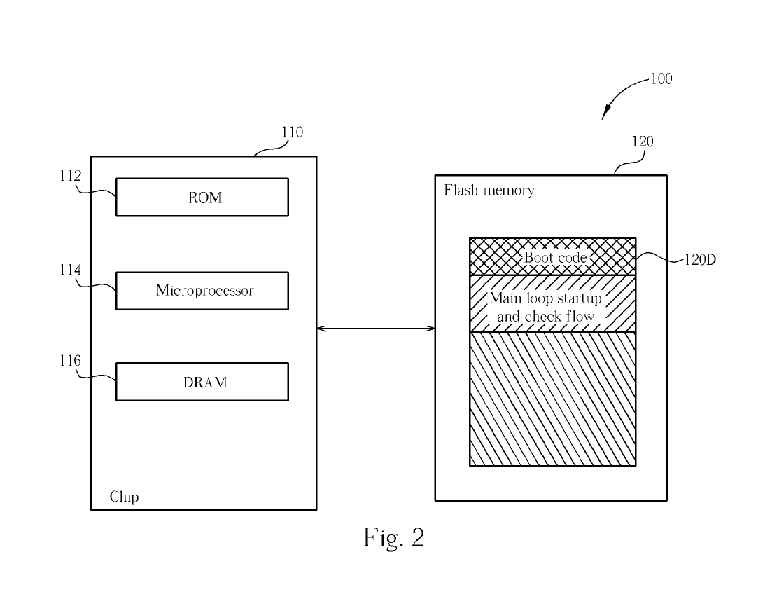

Please refer to FIG. 1 and FIG. 2. FIG. 1 is a flowchart of an integrity check method 910 applied to an electronic device such as those mentioned above (e.g. an optical storage device) according to one embodiment of the present invention, and FIG. 2 is a diagram of a circuit 100 that can be utilized for performing the integrity check method 910. The circuit 100 is positioned in the electronic device where the integrity check method 910 shown in FIG. 1 is applied. In particular, according to this embodiment, the electronic device can be an embedded system.

According to this embodiment, the circuit 100 comprises a chip 110 and a non-volatile memory such as a flash memory 120 (e.g. a parallel flash memory or a serial flash memory), and the chip 110 comprises a read only memory (ROM) 112, a microprocessor 114, and a dynamic random access memory (DRAM) 116. The microprocessor 114 is capable of executing an integrity check program code for controlling the integrity check according to the integrity check method 910 shown in FIG. 1, where the integrity check program code is protected from being altered. In addition, the integrity check program code of this embodiment is implemented by providing a ROM code comprising a boot code and the integrity check program code mentioned above, which are both stored in the ROM 112. The integrity check method 910 shown in FIG. 1 can be described as follows.

In Step 912, derive an initial address and a length of data stored in the non-volatile memory within the electronic device. According to this embodiment, the non-volatile memory is the flash memory 120. In addition, the data 120D stored in the flash memory 120 shown in FIG. 2 comprises a firmware boot code (which can be simply referred to as a boot code, as shown in FIG. 2), a “main loop startup and check flow” program code (which can be referred to as the program code of the main loop startup and check flow, or simply referred to as the main loop startup and check flow, as shown in FIG. 2), and some other data.

According to one implementation choice of this embodiment, only a portion of the data 120D, for example, the boot code and the program code within the data 120D, is predetermined to be checked, so the initial address and the length mentioned above correspond to the boot code and the program code within the data 120D shown in FIG. 2. According to another implementation choice of this embodiment, all the data 120D stored in the flash memory 120 is predetermined to be checked, so the initial address and the length mentioned above correspond to the whole data 120D.

In the loop comprising Step 914 and Step 916, the integrity check method 910 starts fetching data stored in the non-volatile memory into a specific memory. According to this embodiment, the specific memory is the DRAM 116 shown in FIG. 2, and therefore Step 914 fetches data stored in the flash memory 120 into the DRAM 116. Here, the data 120D stored in the flash memory 120 is considered to be “external data” to the specific memory (i.e. the DRAM 116 in this embodiment) since the data 120D in the flash memory 120 is not within the specific memory. According to different implementation choices mentioned above regarding Step 912, at least one portion of the external data (i.e. the data 120D stored in the flash memory 120) is predetermined to be checked, which means the data that is predetermined to be fetched is within the portion of the external data.

In the loop comprising Step 914 and Step 916 according to this embodiment, during fetching the portion of the external data into the specific memory, Step 916 checks whether the size of the fetched data in the specific memory (i.e. the DRAM 116) reaches a predetermined value Dth1, where the predetermined value Dth1 is less than the total size of the external data. In Step 916, if the size of the fetched data in the specific memory reaches the predetermined value Dth1, enter Step 918; otherwise, re-enter Step 914.

In Step 918, enable an integrity check, and complete fetching all the data predetermined to be fetched from the non-volatile memory into the specific memory. The integrity check is not disabled before all the fetched data in the specific memory is checked.

According to different implementation choices of this embodiment, the integrity check mentioned above can be performed according to at least one algorithm of various algorithms such as SHA, CRC, DSA, RSA, EDC, and checksum algorithms. In addition, the predetermined value Dth1 mentioned above is typically predetermined to be a minimum size required for performing the integrity check according to the algorithm. As a result, once the size of the fetched data in the specific memory reaches the minimum size required for performing the integrity check, the integrity check is enabled in Step 918. Therefore, in contrast to the related art, the efficiency of the total operations required for performing the integrity check (e.g. the fetching data and the integrity check operations) is greatly increased according to the present invention since the integrity check is enabled in an earlier phase before all the data predetermined to be fetched from the non-volatile memory into the specific memory is completely fetched.

In Step 920, check whether an integrity check failure occurs. If an integrity check failure occurs, enter Step 922 to stay in the current status to prevent data stored in the non-volatile memory (i.e. the data 120D) from being utilized, so the operation of the electronic device is halted. Conversely, if no integrity check failure occurs, enter a normal phase that is predetermined to be entered, for example, a phase for utilizing the data stored in the non-volatile memory. According to this embodiment, as the non-volatile memory is the flash memory 120, firmware execution utilizing the firmware boot code and the program code of the main loop startup and check flow within the data 120D stored in the flash memory 120 can be the normal phase to be entered, as shown in FIG. 1.

In addition, in Step 914 and Step 918 of this embodiment, the integrity check method 910 may trigger direct memory access (DMA) to fetch the portion of the external data into the specific memory.

According to this embodiment, the ROM 112 is an internal memory of the chip 110. According to a variation of this embodiment, the ROM 112 can be positioned outside the chip 110. According to a variation of this embodiment, the chip 110 is replaced with a processing module comprising the ROM 112, the microprocessor 114, and the DRAM 116, where the processing module has the same functions as those of the chip 110.

According to a variation of this embodiment, the internal memory mentioned above (i.e. the DRAM 116) is replaced with a static random access memory (SRAM), and the integrity check program code stored therein is protected from being altered.

According to a variation of this embodiment, the criterion in Step 916 is slightly changed, where the notation “>” for representing “greater than” is replaced with the notation “≧” for representing “greater than or equal to”.

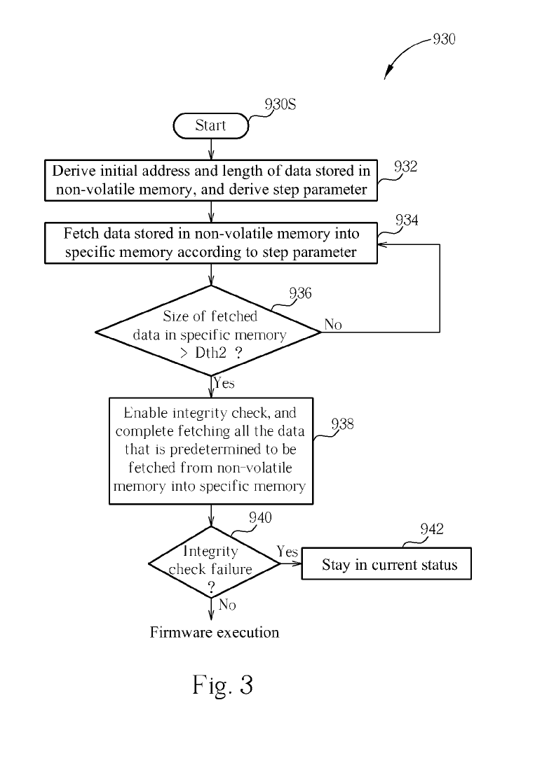

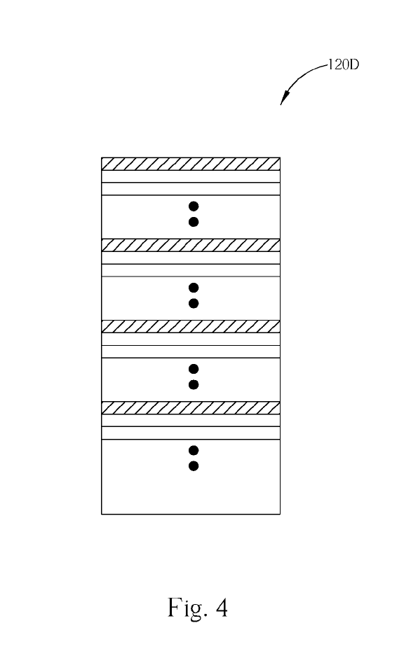

Please refer to FIG. 3 and FIG. 4. FIG. 3 is a flowchart of an integrity check method 930 applied to an electronic device according to one embodiment of the present invention, and FIG. 4 illustrates the data to be fetched from the non-volatile memory as mentioned in the integrity check method 930 shown in FIG. 3.

This embodiment is a variation of the embodiment shown in FIG. 1. In Step 934 and Step 938 of this embodiment, the integrity check method 930 fetches the portion of the external data into the specific memory according to at least one step parameter. According to this embodiment, the step parameter comprises a parameter N which is an integer greater than one. In addition, the portion of the external data (which is the data 120D in this embodiment) comprises one of every N units of the external data, for example, the shaded units shown in FIG. 4.

Although each of the units shown in FIG. 4 seems to be a data block having a plurality of bytes, this is not a limitation of the present invention. According to a variation of this embodiment, each of the one of every N units comprises at least one bit, for example, a single bit, a plurality of bits, one byte, or a plurality of bytes.

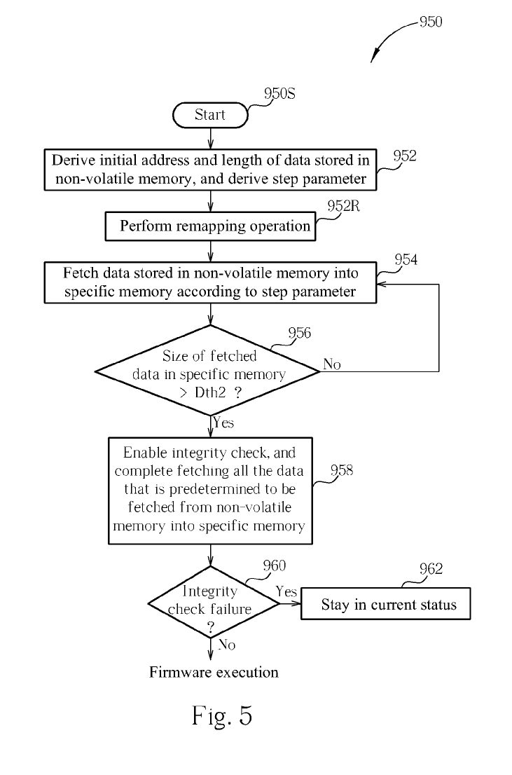

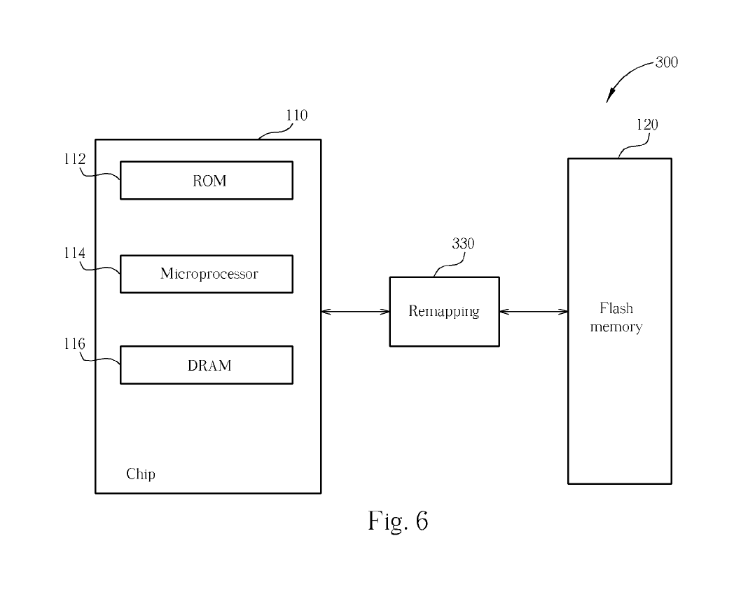

Please refer to FIG. 5 and FIG. 6. FIG. 5 is a flowchart of an integrity check method 950 applied to an electronic device according to one embodiment of the present invention, and FIG. 6 is a diagram of a circuit 300 that can be utilized for performing the integrity check method 950. The circuit 300 is positioned in the electronic device where the integrity check method 950 shown in FIG. 5 is applied.

This embodiment is a variation of the embodiment shown in FIG. 1, and more particularly, a variation of the embodiment shown in FIG. 3. Between Step 952 and Step 954 of this embodiment, the integrity check method 950 performs a remapping operation as shown in Step 952R to remap at least one portion of the fetched data. For example, if the shaded units shown in FIG. 4 represent the portion of the external data, Step 952R may remap the addresses corresponding to the shaded units to scramble the order of the shaded units for fetching into the specific memory.

In contrast to the circuit 100 shown in FIG. 2, the circuit 300 shown in FIG. 6 further comprises a remapping unit 330 for performing the remapping operation mentioned above to remap the portion of the fetched data.

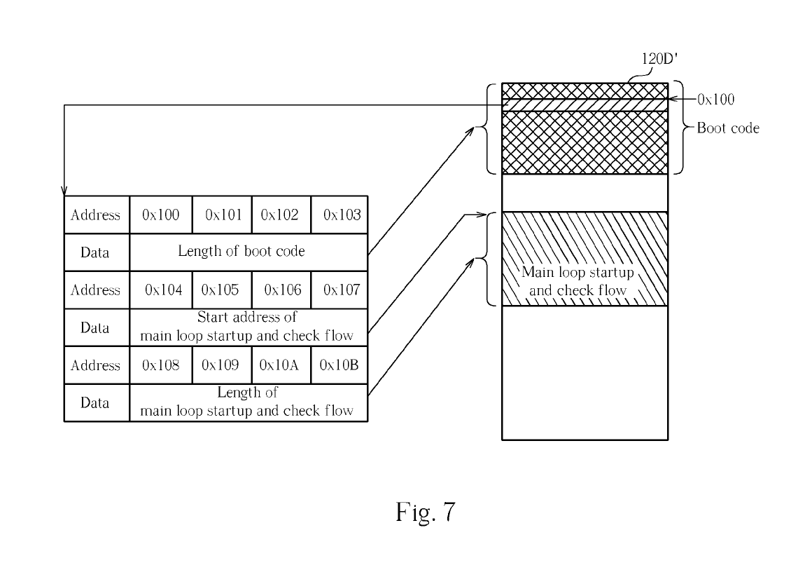

FIG. 7 illustrates a specific portion of the data stored in the non-volatile memory mentioned in the deriving step shown in FIG. 1, FIG. 3, or FIG. 5 according to one embodiment of the present invention, where the specific portion includes parameters for controlling the corresponding fetching step. According to this embodiment, the specific portion includes three parameters respectively corresponding to a length of the boot code in the non-volatile memory (i.e. the firmware boot code), a start address of the main loop startup and check flow, and a length of the main loop startup and check flow, as shown in the table on the left of FIG. 7. As a result, a circuit such as the circuit 100 or the circuit 300 can be utilized in different models of the same kind of electronic devices or utilized in different kinds of electronic devices with an unvaried program code in the ROM 112, where the data in the flash memory 120 can be varied when needed. Therefore, the chip 110 for performing the integrity check method 910, 930, or 950 can be utilized in a wide range of electronic products on the market. Regarding the chip 110, the design cost per lot is greatly reduced as the number of lots increases.

In contrast to the related art, the integrity check methods and related circuits of the present invention have greater efficiency during operations required for performing the integrity check.

It is another advantage of the present invention that the integrity check methods and related circuits of the present invention provide the electronic devices with higher level security in contrast to the related art. The portion of the external data mentioned above, and the control-related data especially, are not too great to be checked in time by utilizing the integrity check methods and related circuits of the present invention.

It is another advantage of the present invention that embedded systems implemented by utilizing the integrity check methods and related circuits of the present invention are cost effective since the design cost per lot is greatly reduced as the number of lots increases. Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An integrity check method applied to an electronic device, comprising:
fetching at least one portion of external data into a specific memory, wherein the external data is stored within the electronic device;
during fetching the at least one portion of the external data into the specific memory, checking whether the size of the fetched data in the specific memory reaches a predetermined value, wherein the predetermined value is less than the total size of the external data; and
when the size of the fetched data in the specific memory reaches the predetermined value, enabling an integrity check of the fetched data.

2. The integrity check method of claim 1, wherein the specific memory is a dynamic random access memory (DRAM).

3. The integrity check method of claim 1, wherein the integrity check is performed according to at least one algorithm of SHA, CRC, DSA, RSA, EDC, and checksum algorithms.

4. The integrity check method of claim 1, wherein the external data is stored in a non-volatile memory within the electronic device.

5. The integrity check method of claim 4, wherein the non-volatile memory is a flash memory.

6. The integrity check method of claim 1, wherein the specific memory is positioned in a chip within the electronic device, and the integrity check method further comprises:
within the chip, providing an internal memory storing an integrity check program code for controlling the integrity check.

7. The integrity check method of claim 6, wherein the internal memory is a read only memory (ROM), and the integrity check program code is protected from being altered.

8. The integrity check method of claim 6, wherein the internal memory is a static random access memory (SRAM), and the integrity check program code is protected from being altered.

9. The integrity check method of claim 1, wherein the at least one portion of the external data comprises all the external data.

10. The integrity check method of claim 1, wherein the step of fetching the at least one portion of the external data into the specific memory further comprises:
fetching the at least one portion of the external data into the specific memory according to at least one step parameter.

11. The integrity check method of claim 10, wherein the at least one step parameter comprises a parameter N which is an integer greater than one, the at least one portion of the external data comprises one of every N units of the external data, and each of the one of every N units comprises at least one bit.

12. The integrity check method of claim 1, further comprising:
triggering direct memory access (DMA) to fetch the at least one portion of the external data into the specific memory.

13. The integrity check method of claim 1, wherein the integrity check is not disabled before all the fetched data in the specific memory is checked.

14. The integrity check method of claim 1, further comprising:
remapping at least one portion of the fetched data.

15. The integrity check method of claim 1, wherein the electronic device is an embedded system.

16. A circuit for performing an integrity check in an electronic device, comprising:
a specific memory for temporarily storing at least one portion of external data, wherein the external data is stored within the electronic device; and
a microprocessor, coupled to the specific memory, for fetching the at least one portion of external data into the specific memory, wherein during fetching the at least one portion of the external data into the specific memory, the microprocessor checks whether the size of the fetched data in the specific memory reaches a predetermined value, and the predetermined value is less than the total size of the external data;
wherein when the size of the fetched data in the specific memory reaches the predetermined value, the microprocessor enables the integrity check of the fetched data.

17. The circuit of claim 16, wherein the specific memory is a dynamic random access memory (DRAM).

18. The circuit of claim 16, wherein the integrity check is performed according to at least one algorithm of SHA, CRC, DSA, RSA, EDC, and checksum algorithms.

19. The circuit of claim 16, further comprising:
a non-volatile memory for storing the external data.

20. The circuit of claim 19, wherein the non-volatile memory is a flash memory.

21. The circuit of claim 16, wherein at least one portion of the circuit is integrated into a chip.

22. The circuit of claim 16, further comprising:
an internal memory, coupled to the microprocessor, for storing an integrity check program code for controlling the integrity check;
wherein the microprocessor is capable of executing the integrity check program code to control the integrity check.

23. The circuit of claim 22, wherein the internal memory is a read only memory (ROM), and the integrity check program code is protected from being altered.

24. The circuit of claim 22, wherein the internal memory is a static random access memory (SRAM), and the integrity check program code is protected from being altered.

25. The circuit of claim 16, wherein the at least one portion of the external data comprises all the external data.

26. The circuit of claim 16, wherein the microprocessor fetches the at least one portion of the external data into the specific memory according to at least one step parameter.

27. The circuit of claim 26, wherein the at least one step parameter comprises a parameter N which is an integer greater than one, the at least one portion of the external data comprises one of every N units of the external data, and each of the one of every N units comprises at least one bit.

28. The circuit of claim 16, wherein the microprocessor triggers direct memory access (DMA) to fetch the at least one portion of the external data into the specific memory.

29. The circuit of claim 16, further comprising:
a remapping unit for remapping at least one portion of the fetched data.

30. The circuit of claim 16, wherein the electronic device is an embedded system.
